(19) United States
(12) Patent Application Publication
(10) Pub. No.: US 2006/0137832 A1
(43) Pub. Date: Jun. 29, 2006

(54) Overhead track screen door for garages

(76) Inventor: Howard Alexander, Clermont, FL (US)

Correspondence Address: LITMAN LAW OFFICES, LTD, PO BOX 15035, CRYSTAL CITY STATION, ARLINGTON, VA, 22215, US

(21) Appl. No.: 11/023,508

(22) Filed: Dec. 29, 2004

(51) Int. Cl. E06B 3/48

(52) U.S. Cl. 160/113

(57) ABSTRACT

An overhead track screen door system for garages has generally parallel screen door tracks spaced inward and downward from those of an overhead garage door. The overhead track screen door has articulated hinged, screened frames having rollers mounted at each end which travel in tracks between a horizontal overhead open position and a closed position spaced inward from the overhead garage door. The overhead door tracks and overhead screen door tracks are mounted to common vertical mounting plates at each side of the garage entrance. A horizontal resilient wipe seal is mounted on the interior side of the outer door lower panel sealing between the outer door and the inner screen door against insects. The lower inner screen door tracks are angled inward at an acute angle relative to the lower outer door tracks to ease opening of the inner screen door. The screen door has a locking latch system.

### BACKGROUND OF THE INVENTION

1. Field of the Invention

The present invention relates to overhead doors. More particularly, the present invention relates to overhead screen doors for garages.

2. Description of the Related Art

The use of overhead doors for garages such as those attached to houses is common. It is also common to use the space in the garage for entertaining, automobile maintenance, woodworking and other shop work, and as a substitute for a porch. In warm weather, particularly in summer, it is desirable to open the overhead door during activities for ventilation, it being impractical to provide the garage with air conditioning. In many localities, flying insects are pests, making it desirable to screen them from the garage during use. Most overhead doors have articulated hinged panels having rollers mounted at each panel end which travel in tracks between a horizontal overhead open position and a vertical closed position. It would be desirable to provide an overhead screen door which does not interfere with the use of the overhead door which is effective in maintaining the garage interior free of flying insects, while maintaining maximum ventilation. It would also be desirable to provide such a screen door which is easily opened and closed and has a secure latch for locking in the closed position for security when absent from the garage.

Thus an overhead track screen door for garages solving the aforementioned problems is desired.

### SUMMARY OF THE INVENTION

The overhead track screen door system for garages has generally parallel screen door tracks spaced inward and downward from those of an overhead garage door. The overhead track screen door has articulated hinged, screened frames forming panels having rollers mounted at each end which travel in tracks between a horizontal overhead open position and a closed position spaced inward from and extending upward at an acute inward angel relative to the vertical overhead garage door. The overhead door tracks and overhead screen door tracks are mounted to common vertical mounting plates at each side of the garage entrance. The horizontal overhead screen door tracks are mounted by hanging from respective horizontal overhead door tracks by stiff hangers.

A horizontal resilient wipe seal is mounted on the interior side of the outer garage door lower panel which provides for a seal between the outer door and the inner screen door to prevent entry of flying insects. The wipe seal allows sealing between the outer door when open or partially down with the outer surface of the inner screen door when in a closed position. This allows for partial opening of the outer door during cooler weather or during a rainstorm while the screen door remains closed. The inner screen door tracks are angled inward at an acute angle relative to the outer door tracks in the vertical closing portions thereof, so as to ease lifting of the inner screen door. The screen door has a locking latch system similar to that of an outer overhead door for security during absence or to avoid unwanted guests.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an inside perspective view, partially broken away, of the garage screen door system overhead track screen door for garages with both the garage door and screen door in the open position according to the present invention.

FIG. 2 is a perspective view similar to that of FIG. 1, with the screen door in the closed position and the garage door in the open position.

FIG. 3 is a detail, outer perspective view of the wipe seal structure as attached to the inner side of the garage door and sealing against the screen door of FIG. 1.

FIG. 4 is a detail view of the screen door latch system of the screen door of FIG. 1.

FIG. 5 is an outer perspective view of the garage screen door system of FIG. 1 with the screen door fully down and the garage door partially open.

Similar reference characters denote corresponding features consistently throughout the attached drawings.

### DETAILED DESCRIPTION OF THE PREFERRED EMBODIMENTS

The present invention is an overhead track screen door system for garages. An outer track overhead door has supports a horizontal wipe seal extending to the inner screen door to prevent entry of insects between the overhead door, when in an open or partially open position, and the closed screen door.

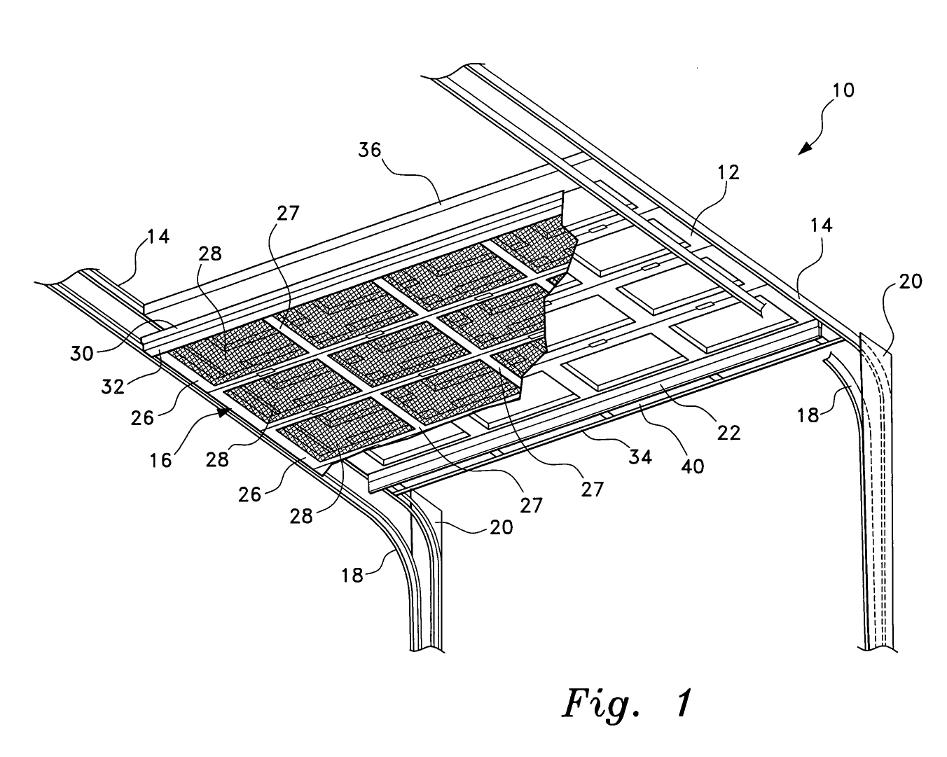

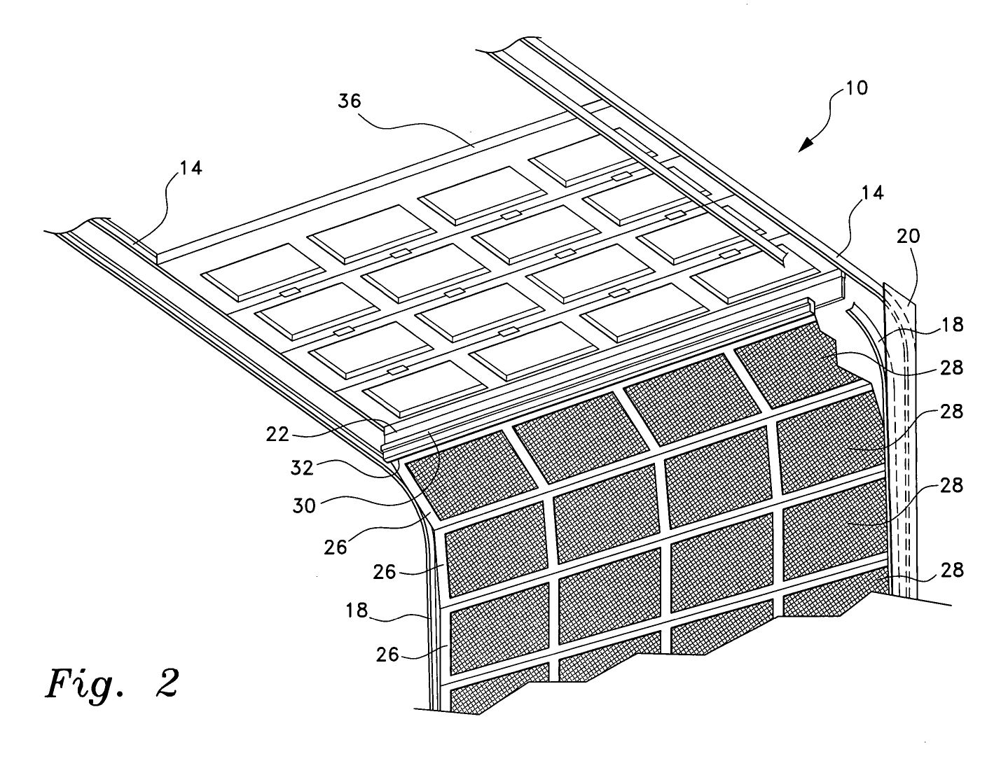

Referring to FIGS. 1 and 2, there is shown inner perspective views of the overhead track screen door system of the present invention with both doors in the open position, and with the screen door closed with the garage door open, respectively, the system in its totality being referred to by the reference No. 10. Overhead track screen door system 10 includes an overhead track articulated, hinged panel garage door 12 supported at each side by rollers (not shown) on outer door tracks 14, and an articulated, hinged screened panel screen door 18 similarly supported at each side on inner screen door tracks 18. The spaced tracks are supported at each side of the garage entrance (not shown) by vertical track mounting plates 20. The outer door tracks 14 have a generally vertically disposed lower closed portion curving upward and inward relative to the garage to a horizontal upper open portion. The inner screen door tracks 18 have a generally vertically disposed lower closed portion spaced inward from the generally vertical portion of outer door tracks 14, curving upward and inward relative to the garage to a horizontal upper open portion spaced below the corresponding outer door tracks 14. The upper portions of the inner screen door tracks 18 are supported by relatively stiff hangers (not shown) mounted to the upper portions of the outer garage door tracks as installed in the garage. The screen door 16 in the open position is spaced downward from the outer garage door 12 when in the open position so as to allow clearance for the garage door opening system (not shown).

Resilient wipe seal 22 extends laterally along the inner side of the garage door lower panel 40 and seals against the articulated screen panels 26 on their outer side as the screen door 16 is opened or closed to avoid entry of insects between the two doors. Articulated screen panels 26 support wire or plastic screens 28 and are attached between panel frames 27 by hinges in a manner similar to that of the outer garage door 12.

Screen door 16 has an upper end frame 30 having an upper end frame stiffener 32 and a lower end frame 38. Outer garage door 12 has an upper end frame 36 and a lower end frame 34 at its lower edge.

As best seen in FIGS. 2, 3, and 5, the closure portion of the inner screen door tracks 18 are mounted at an acute inward angle relative to the vertical portion of the outer garage door tracks 14. The acute angle is preferably about 6 degrees, but may vary for a particular installation. This arrangement allows for hand raising of screen door 16 with less upward force than if it was vertically mounted.

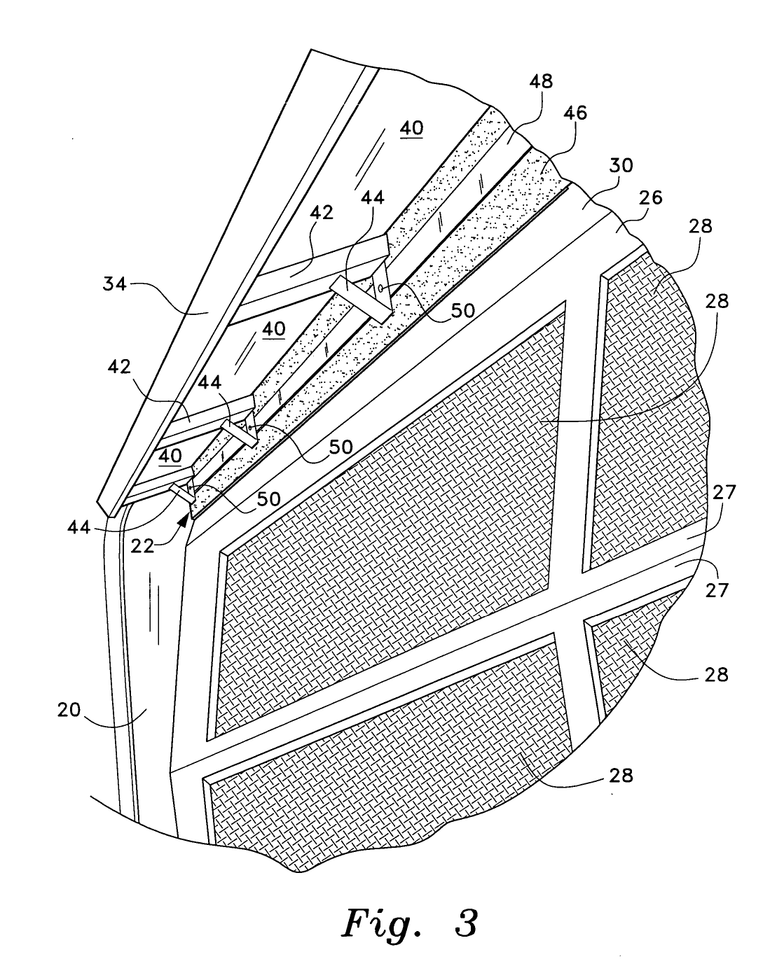

Referring to FIG. 3, there is shown a detail outer perspective view of the wipe seal structure as attached to the inner side of the garage door 12 and sealing against the outer side of screen door 16 with the garage door 12 in the open position and the screen door 16 in the closed position. Resilient wipe seal 22 is mounted horizontally on the inner side of garage door lower panel 40. Wipe seal 22 includes a generally rectangular, elongate resilient element 46, preferably a strip of rubber, polymeric material, or the like. Wipe seal resilient element 56 is a supported along its length by support bar 48 on the lower side thereof and spaced between horizontal edges. Support bar 48 is a rigid strip, preferably of metal such as aluminum, and is attached along its length by spaced wipe seal angle supports 44 by support bar fasteners 50. Wipe seal angle supports 44 are attached in a conventional manner to respective wipe seal panel supports 42 which are of rectangular stock, each extending between garage door lower end frame 34 and resilient seal 48.

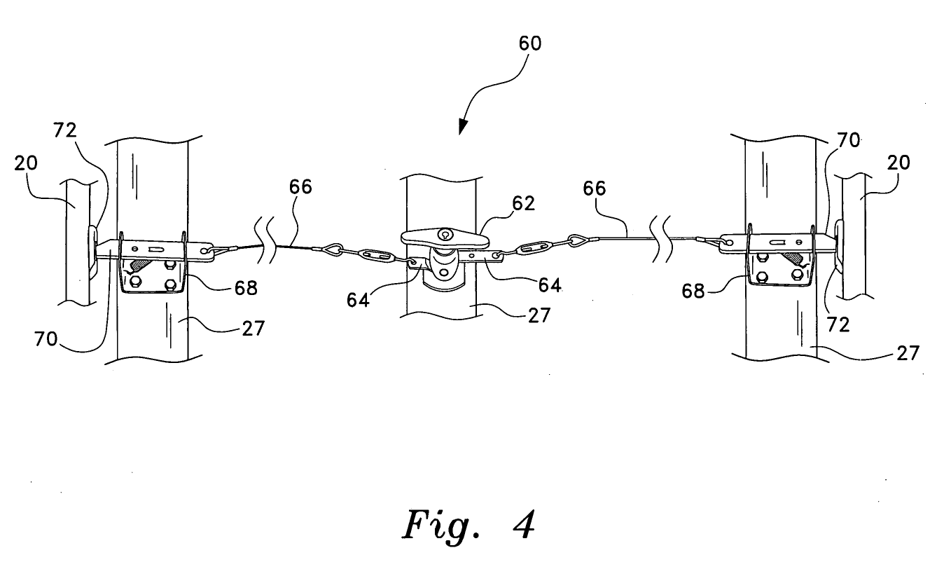

Referring to FIG. 4, there is shown a detail view of screen door latch system 60 as mounted on the inner side of panel frames 27 at a convenient height. Latch handle 62 is a conventional locking twist type overhead door latch having latch handle pulls 64 extending laterally from each side. Latch cables 66 operate, latches 70 mounted to the remote vertical panel frames 27 by spring loaded latch supports. Latch cables 66 are attached, respectively to latch handle pulls 64. Latch receivers 72 are attached to track mounting plates 20 or other convenient structure and receive the spring-biased latches 70 when screen door 16 is in the closed position where it may be locked in place. Upon turning latch handle 62, latch cables 66 pull latches 70 inward, releasing them from latch receivers 72, allowing the operator to lift the screen door to the open, overhead position.

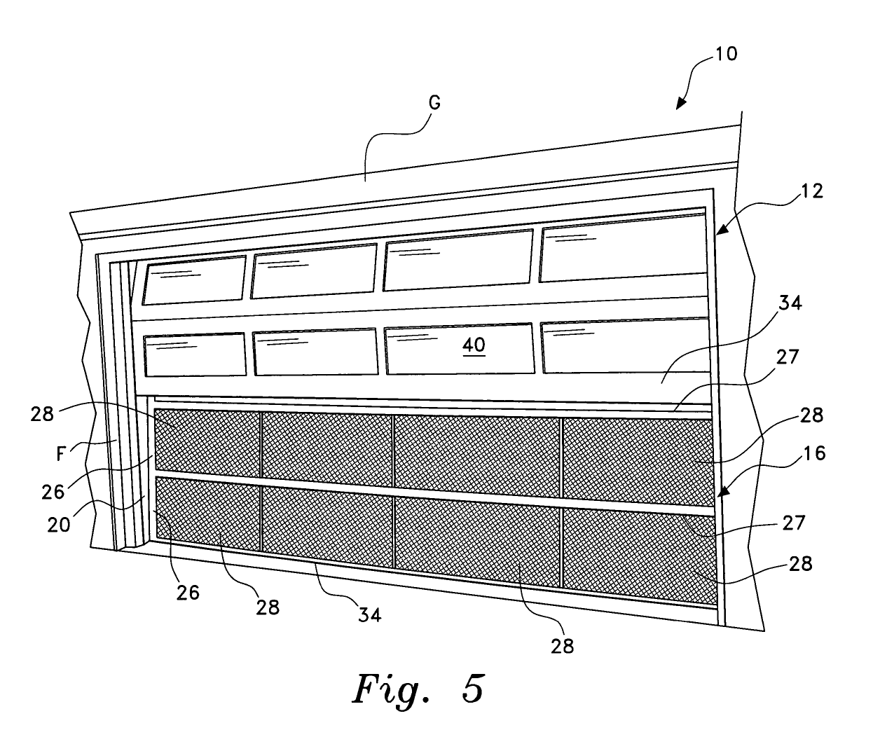

Referring to FIG. 5, there is shown an environmental perspective view of the overhead door screen system 10 as mounted in the doorframe F of a garage G. Overhead door screen system 10 is shown with the panel garage door 12 located in a half closed position relative to the closed panel screen door 16. This position would ordinarily be used when ventilation is needed, but it is desirable to provide shade for the occupant or retain heat. The resilient wipe seal 22, mounted on the inner side of outer door panel 40 (see FIG. 3, above) maintains an effective seal between outer door 40 and the outer surface of inner screen door 16 for purposes of denying entry to flying insects, birds, or other animals.

It is to be understood that the present invention is not limited to the embodiments described above, but encompasses any and all embodiments within the scope of the following claims.

I claim:

1. An overhead track screen door system for door openings of garages, comprising:
a pair of spaced overhead garage outer door tracks mounted on opposed sides of a garage door opening;
said spaced overhead garage outer door tracks having a lower, generally vertical closed portion curving upward to form an upper, horizontal open portion;
an outer overhead garage door extending between said outer door tracks and supported for motion relative thereto and so configured as to selectively travel between a closed position closing the door opening along said generally vertical portion of said spaced overhead garage outer door tracks and said upper, horizontal portion of said spaced overhead garage door tracks;
a pair of spaced inner screen door tracks mounted on opposed sides of the garage door opening;
said spaced inner screen door tracks having a lower, generally vertical, closed portion spaced inward relative to said garage from said spaced overhead garage outer door tracks, and curving upward to form an upper, horizontal open portion spaced below said upper, horizontal portion of corresponding said overhead garage door tracks; and
an inner screen door extending between said inner screen door tracks and supported for motion relative thereto and so configured as to selectively travel between a closed position closing the door opening along said generally vertical portion of said spaced inner screen door tracks and said upper, horizontal portion of said spaced screen door tracks;
said outer garage door having a lower portion and an upper portion, and an inner side and an outer side;
said inner screen door having a lower portion and an upper portion, and an inner side and an outer side; and
said outer garage door having a resilient wipe seal horizontally disposed along its width and extending inward so as to seal against said outer side of said inner screen door;
whereby upon said outer garage door being in a raised, open or partially open position, and said inner screen door being in a lowered, closed position, said wipe seal engages said inner screen door so as to deny entry of flying insects into the garage.

2. The overhead track screen door system of claim 1, wherein said garage outer door is an articulated, horizontal hinged panel overhead door, and said inner screen door is an articulated, horizontal hinged screen frame panel overhead door.

3. The overhead track screen door system of claim 2, wherein said lower portion of said garage outer door comprises a lower panel and said resilient wipe seal is mounted to and spaced upward from the lower edge of said lower panel.

4. The overhead track screen door system of claim 3, wherein said resilient wipe seal comprises an elongated rectangular strip of resilient material supported by a support bar extending the horizontal length of said rectangular strip.

5. The overhead track screen door system of claim 4, wherein said support bar is supported by angle supports spaced therealong.

6. The overhead track screen door system of claim 5, further comprising vertically oriented panel supports extending upward from about the lower edge of said lower panel on the inner side thereof, said angle supports being mounted at the upper portion of corresponding said panel supports so as to extend said elongated resilient rectangular strip inward from said inner surface of said panel.

7. The overhead track screen door system of claim 2, wherein said generally vertical portion of said spaced inner screen door tracks are located at an upper, inner acute angle relative to vertical said spaced overhead garage outer door tracks, whereby said vertical portions of said inner screen door tracks require minimal force to lift and thereby open said inner screen door to the upper, horizontal position.

8. The overhead track screen door system of claim 7, wherein said inner acute angle between said inner screen door tracks and said overhead garage outer door tracks is about 6 degrees.

9. The overhead track screen door system of claim 7, further comprising a pair of spaced track mounting plates disposed at opposite sides of the garage door opening and to which corresponding said generally vertical and upward curved portions of said overhead garage outer door tracks and said generally vertical and upward curved portions of said inner screen door tracks are mounted.

10. The overhead track screen door system of claim 2, further comprising a screen door latch system located on said inner side of said screen door, said screen door latch system comprising:
a rotatable handle having opposed latch handle pulls, a pair of spring loaded latch supports;
a pair of latches having latch cables connected to said latch handle pulls; and
a pair of latch receivers mounted on respective said track mounting plates;
said rotatable handle being mounted on a centrally located, vertical portion of a selected one of said screen door frames of said screen panel, said pair of latch supports being mounted on vertical portions of said screen panel at points adjacent respective track mounting plates;
said latch receivers latch receivers receiving said latches for securing said inner screen door;
said latches being pulled from said latch receivers upon turning of said rotatable handle.

11. An overhead track screen door system for door openings of garages, comprising:
a pair of spaced overhead garage outer door tracks mounted on opposed sides of a garage door opening;
said spaced overhead garage outer door tracks having a lower, generally vertical closed portion curving upward to form an upper, horizontal open portion;
an outer overhead garage door extending between said outer door tracks and supported for motion relative thereto and so configured as to selectively travel between a closed position closing the door opening along said generally vertical portion of said spaced overhead garage outer door tracks and said upper, horizontal portion of said spaced overhead garage door tracks;
a pair of spaced inner screen door tracks mounted on opposed sides of the garage door opening;
said spaced inner screen door tracks having a lower, generally vertical, closed portion spaced inward relative to said garage from said spaced overhead garage outer door tracks, and curving upward to form an upper, horizontal open portion spaced below said upper, horizontal portion of corresponding said overhead garage door tracks; and
an inner screen door extending between said inner screen door tracks and supported for motion relative thereto and so configured as to selectively travel between a closed position closing the door opening along said generally vertical portion of said spaced inner screen door tracks and said upper, horizontal portion of said spaced screen door tracks;
said outer garage door having a lower portion and an upper portion, and an inner side and an outer side;
said inner screen door having a lower portion and an upper portion, and an inner side and an outer side; and
said generally vertical portion of said spaced inner screen door tracks being located at an upper, inner acute angle relative to vertical said spaced overhead garage outer door tracks;
whereby said vertical portions of said inner screen door tracks require minimal force to lift and thereby open said inner screen door to the upper, horizontal position.

12. The overhead track screen door system of claim 11, wherein said inner acute angle between said inner screen door tracks and said overhead garage outer door tracks is about 6 degrees.

13. The overhead track screen door system of claim 12, wherein said garage outer door is an articulated, horizontal hinged panel overhead door, and said inner screen door is an articulated, horizontal hinged screen frame panel overhead door.

14. The overhead track screen door system of claim 13, said outer garage door having a resilient wipe seal horizontally disposed along its width and extending inward so as to seal against said outer side of said inner screen door, whereby upon said outer garage door being in a raised, open or partially open position, and said inner screen door being in a lowered, closed position, said wipe seal engages said inner screen door so as to deny entry of flying insects into the garage.

15. The overhead track screen door system of claim 14, wherein said lower portion of said garage outer door comprises a lower panel and said resilient wipe seal is mounted to and spaced upward from the lower edge of said lower panel.

16. The overhead track screen door system of claim 15, wherein said resilient wipe seal comprises an elongated rectangular strip of resilient material supported by a support bar extending the horizontal length of said rectangular strip.

17. The overhead track screen door system of claim 16, wherein said support bar is supported by angle supports spaced therealong.

18. The overhead track screen door system of claim 17, further comprising vertically oriented panel supports extending upward from about the lower edge of said lower panel on the inner side thereof, said angle supports being mounted at the upper portion of corresponding said panel supports so as to extend said elongated resilient rectangular strip inward from said inner surface of said panel.

19. The overhead track screen door system of claim 18, further comprising a pair of spaced track mounting plates disposed at opposite sides of the garage door opening and to which corresponding said generally vertical and upward curved portions of said overhead garage outer door tracks and said generally vertical and upward curved portions of said inner screen door tracks are mounted.

20. The overhead track screen door system of claim 19, further comprising a screen door latch system located on said inner side of said screen door, said screen door latch system comprising:
a rotatable handle having opposed latch handle pulls, a pair of spring loaded latch supports;
a pair of latches having latch cables connected to said latch handle pulls; and
a pair of latch receivers mounted on respective said track mounting plates;
said rotatable handle being mounted on a centrally located, vertical portion of a selected one of said screen door frames of said screen panel, said pair of latch supports being mounted on vertical portions of said screen panel at points adjacent respective track mounting plates;
said rotatable handle being mounted on a centrally located, vertical portion of a selected one of said screen door frames of said screen panel, said pair of latch supports being mounted on vertical portions of said screen panel at points adjacent respective track mounting plates;
said latch receivers latch receivers receiving said latches for securing said inner screen door;
said latches being pulled from said latch receivers upon turning of said rotatable handle.
